(19) United States
(12) Patent Application Publication
(10) Pub. No.: US 2024/0149364 A1
(43) Pub. Date: May 9, 2024

(54) METHOD FOR JOINING AND REPAIRING RAILS

(71) Applicant: Paul Po CHENG, London (CA)

(72) Inventor: Paul Po CHENG, London (CA)

(21) Appl. No.: 18/279,259

(22) PCT Filed: Mar. 1, 2022
(86) PCT No.: PCT/CA2022/050286

§ 371 Date: Aug. 29, 2023

Related U.S. Application Data
(60) Provisional application No. 63/155,360, filed on Mar. 2, 2021.

(51) Int. Cl. B23K 9/00

(52) U.S. Cl. CPC B23K 9/0026

(57) ABSTRACT

A method of forming a fused rail assembly in which one or more heating elements are positioned in a gap between first and second end faces of aligned first and second rails. The end faces are covered by a non-oxidizing atmosphere, and the heating elements are energized, to heat portions of the first and second rails to a predetermined hot working temperature. While one or more of the first end faces is moving transversely relative to center lines of the rails, and while the heated portions are at the predetermined hot working temperature, the first and second end faces are engaged with each other, to fuse together, forming the fused rail assembly. The transverse motion of the first end face or the second end face or both may commence before or after the first and second end faces are engaged.

### CROSS-REFERENCE TO RELATED APPLICATION

This application claims the benefit of U.S. Provisional Patent Application No. 63/155,360, filed on Mar. 2, 2021, the entirety of which provisional application is hereby incorporated herein by reference.

### FIELD OF THE INVENTION

The present invention is a method of joining and repairing rails.

### BACKGROUND OF THE INVENTION

In the prior art, rails are produced in standard lengths by steel producers. The rails ultimately are required to be joined together in the field. Conventional methods of welding rails together include, for example, thermite welding, and flash-butt welding. The conventional methods result in a heat-affected zone in the joined rails. The heat-affected zone typically extends outwardly into both rails, from a weld interface or joint at which the two rails are joined by molten metal.

The material in the heat-affected zone has been adversely affected by heat from the molten metal used in the conventional welding processes. Typically, the material in the heat-affected zone is weaker, or softer, than material outside the heat-affected zone. As is well known in the art, because the heat-affected zones provide regions in which the characteristics of the material (e.g., steel) vary widely, the rails are prone to failure in or near the heat-affected zones, sometimes at the weld interface.

As can be seen in FIG. 1, a conventional rail 10 includes a head 12, a foot 14, and a web 16 joining the head 12 and the foot 14. (The balance of the drawings illustrate the invention.) Various defects in conventional rails (e.g., internal defects, surface cracks, and spalling from the head) are believed to arise due to the conventional methods of welding the rails together.

### SUMMARY OF THE INVENTION

For the foregoing reasons, there is a need for a method and a system for joining rails together that overcomes or mitigates the defects and deficiencies of the prior art.

In its broad aspect, the invention provides a method of forming a fused rail assembly in which one or more heating elements are positioned in a gap between first and second end faces of aligned first and second rails. The end faces are covered by a non-oxidizing atmosphere, and the heating elements are energized, to heat portions of the first and second rails to a predetermined hot working temperature. While one or more of the first end faces is moving transversely relative to center lines of the rails, and while the heated portions are at the predetermined hot working temperature, the first and second end faces are engaged with each other, to fuse together, forming the fused rail assembly. The transverse motion may begin before or after the first and second ends are engaged.

### BRIEF DESCRIPTION OF THE DRAWINGS

The invention will be better understood with reference to the attached drawings, in which:

FIG. 1 (previously described) is an end view of a conventional rail;

FIG. 2A is a side view of first and second rails with heating elements positioned therebetween, drawn at a smaller scale;

FIG. 2B is a side view of the first and second rails of FIG. 2A, after the heating elements are removed;

FIG. 2C is a top view of the first and second rails of FIG. 2B;

FIG. 2D is a side view of the first and second rails of FIGS. 2A-2C, with the first and second ends thereof engaged with each other, to form an embodiment of the fused rail assembly of the invention;

FIG. 2E is a side view of the fused rail assembly of FIG. 2D showing excess top and side material located thereon;

FIG. 2F is a cross-section of the fused rail assembly of FIG. 2E, drawn at a larger scale;

FIG. 3A is a side view of first and second rails, with an embodiment of an intermediate element of the invention positioned therebetween and heating elements positioned therebetween, drawn at a smaller scale;

FIG. 3B is a side view of the first and second rails and the intermediate element of FIG. 3A after the heating elements are removed;

FIG. 3C is a side view of the first and second rails of FIG. 3B with the first and second ends thereof engaged with opposite sides of the intermediate element, to form an alternative embodiment of the fused assembly of the invention;

FIG. 3D is a cross-section of the fused assembly of FIG. 3C, drawn at a larger scale;

FIG. 3E is a side view of the fused rail assembly of FIG. 3C showing excess top and side material located thereon, drawn at a smaller scale;

FIG. 3F is a top view of the fused rail assembly of FIG. 3E;

FIG. 3G is a side view of an alternative embodiment of the fused rail assembly of the invention;

FIG. 3H is a side view of a completed fused rail assembly of the invention;

FIG. 4A is a side view of first and second rails, with an alternative embodiment of an intermediate element of the invention positioned therebetween and heating elements positioned therebetween;

FIG. 4B is a side view of the first and second rails and the intermediate element of FIG. 4A after the heating elements are removed;

FIG. 4C is an end view of the intermediate element of FIGS. 4A and 4B, drawn at a larger scale;

FIG. 4D is a side view of the first and second rails of FIG. 4B with the first and second ends thereof engaged with opposite sides of the intermediate element to form an embodiment of the fused rail assembly of the invention, drawn at a smaller scale;

FIG. 4E is a side view of the fused rail assembly of FIG. 4D showing excess top and side material located thereon;

FIG. 4F is a top view of the fused rail assembly of FIG. 4E;

FIG. 4G is a side view of a completed fused rail assembly of the invention;

FIG. 5A is a side view of a rail having damaged regions on the head thereof;

FIG. 5B is an end view of a rail having a damaged region on the head thereof, drawn at a larger scale;

FIG. 5C is a side view of the rail of FIG. 5A showing replacement elements positioned relative to cavities formed in the rail, drawn at a smaller scale;

FIG. 5D is an end view of the rail of FIG. 5B showing a replacement element positioned relative to a cavity formed in the rail, drawn at a larger scale;

FIG. 5E is a side view of the rail of FIG. 5C in which the rail is repaired, drawn at a smaller scale;

FIG. 5F is an end view of the rail of FIG. 5D in which the rail is repaired, drawn at a larger scale; and

FIG. 5G is an end view of the rail of FIG. 5D in which excess material is positioned adjacent to the replacement portion, drawn at a larger scale.

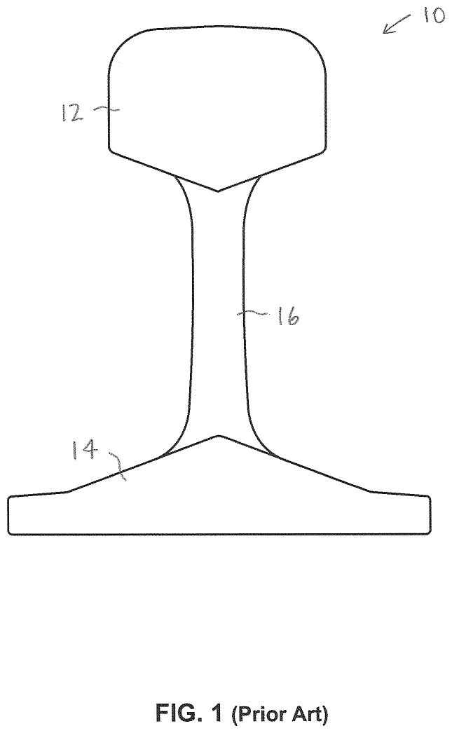

### DETAILED DESCRIPTION

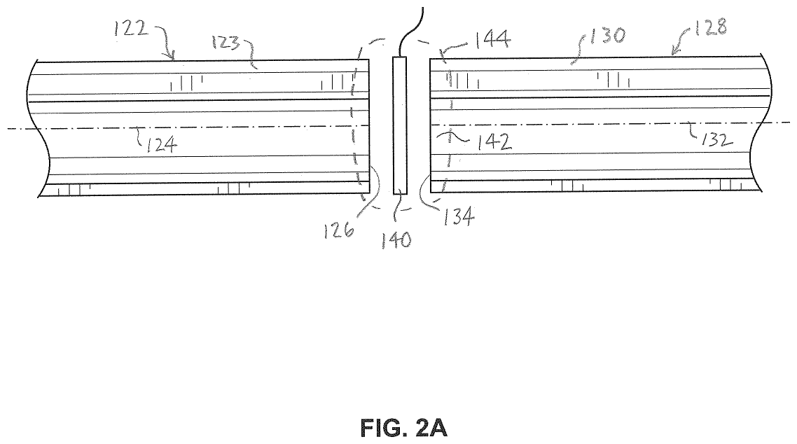

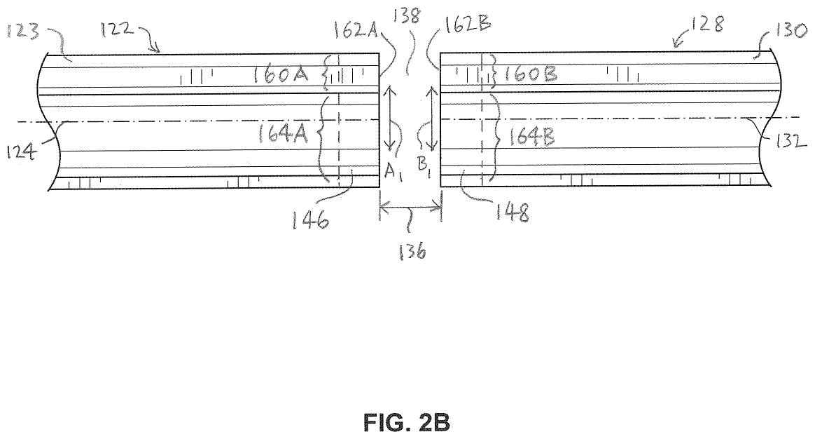

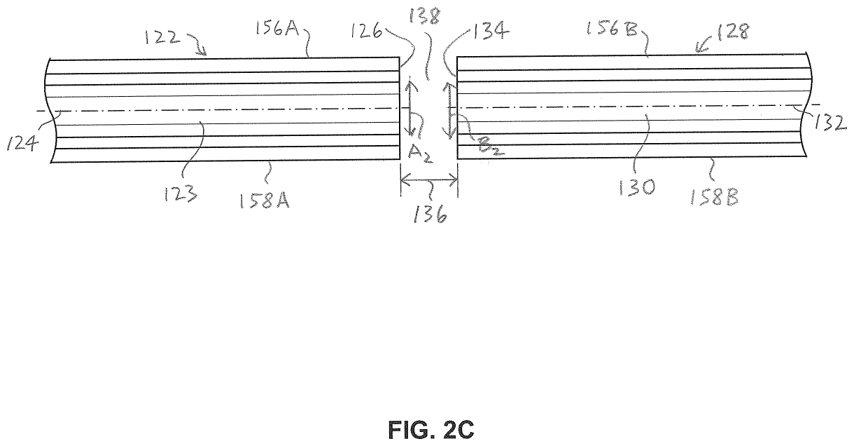

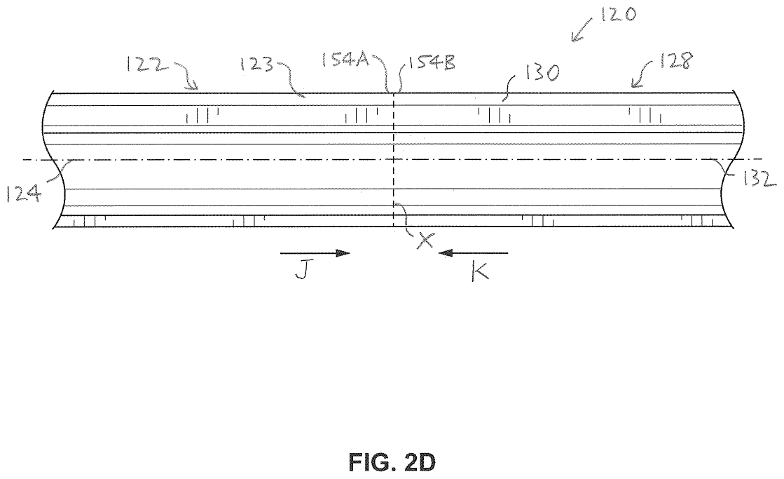

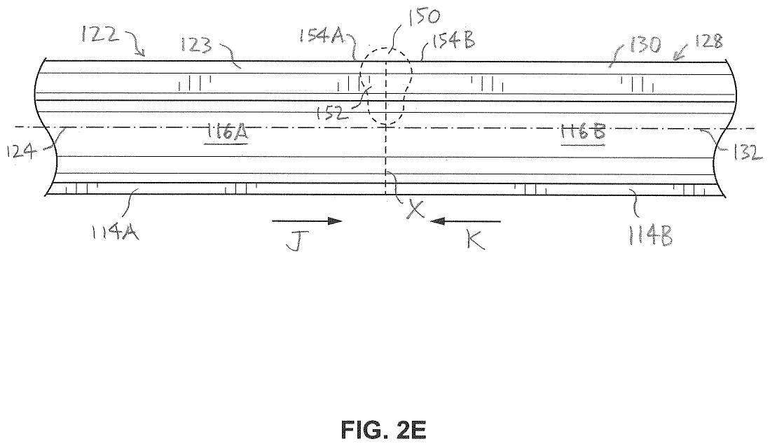

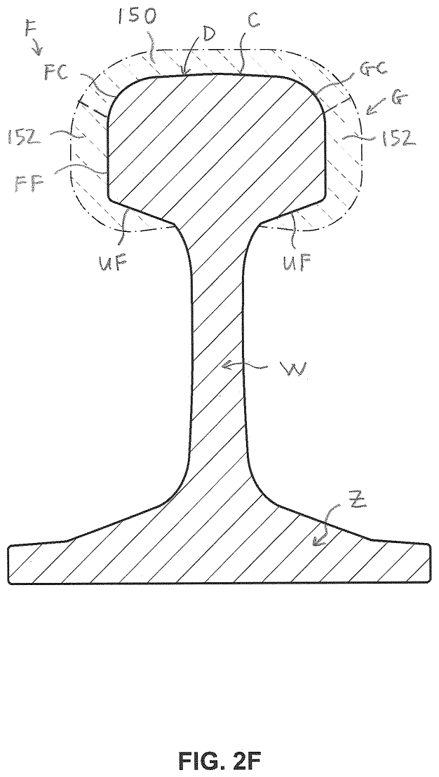

In the attached drawings, like reference numerals designate corresponding elements throughout. Reference is first made to FIGS. 2A-2F to describe an embodiment of a method of forming a fused rail assembly 120 (FIG. 2D) in accordance with the invention.

In one embodiment, the method of forming the fused rail assembly 120 preferably includes providing a first rail 122 having a first rail head 123. The first rail 122 ends at a first end face 126 thereof. A second rail 128 is provided that has a second rail head 130. As can be seen in FIGS. 2A-2D, the first rail 122 defines a first rail center line 124 thereof, and the second rail 128 defines a second rail center line 132 thereof. The second rail 128 also ends at a second end face 134 thereof.

Preferably, the first and second rails 122, 128 are positioned to locate the first and second end faces 126, 134 facing each other, and to align the first and second rail center lines 124, 132 (FIG. 2A). The first and second end faces 126, 134 preferably are spaced apart from each other by a predetermined distance 136 to define an opening 138 between the first and second end faces 126, 134 (FIGS. 2B, 2C).

It is also preferred that one or more heating elements 140 are provided. As can be seen in FIG. 2A, the heating elements 140 preferably are located in the opening 138. To simplify the illustration, only one heating element 140 is shown in FIG. 2A. It will be understood that the heating element 140 is omitted from FIGS. 2B and 2C for clarity of illustration.

A non-oxidizing or inert atmosphere is provided, to cover the first and second end faces 126, 134 while they are heated. In FIG. 2A, the non-oxidizing atmosphere covers a region identified by reference character 142. Those skilled in the art would appreciate that a cover 144 (schematically represented by a dashed line in FIG. 2A) preferably is provided to contain the non-oxidizing atmosphere in the region 142, so that the non-oxidizing atmosphere covers the first and second end faces 126, 134 while the heating elements 140 are energized. It will also be understood that the cover 144 containing the non-oxidizing atmosphere is removed after the heating element 140 is de-energized, as will be described. Because those skilled in the art would be familiar with a non-oxidizing atmosphere, further description thereof is unnecessary.

Once the non-oxidizing atmosphere is in place, the heating element 140 is energized, to heat the first end face 126 and a first length portion 146 of the first rail 122 extending from the first end face 126 into the first rail 122 by induction heating to a predetermined hot working temperature, at which the first end face 126 and the first length portion 146 are plastically deformable (FIG. 2B). The energized heating element 140 also heats the second end face 134 and a second length portion 148 of the second rail 128 extending from the second end face 134 into the second rail 128 by induction heating to the predetermined hot working temperature, at which the second end face 134 and the second length portion 148 are plastically deformable (FIG. 2B).

Those skilled in the art would appreciate that a hot working temperature of a metal is less than a melting temperature thereof. A metal (i.e., metal or alloy) may have a range of hot working temperatures. It will be understood that the predetermined hot working temperature is an optimum hot working temperature. For instance, a relatively low hot working temperature may be considered optimum due to relatively low energy inputs.

Those skilled in the art would appreciate that the heating elements may include one or more induction coils.

Preferably, where more than one heating element 140 is utilized, all the heating elements 140 may be energized at substantially the same time, and de-energized at substantially the same time. However, as will be described, it may be advantageous to energize certain heating elements before others, to preheat the heads 123, 130.

Those skilled in the art would appreciate that, when all of the heating elements 140 are energized, all of the first and second end faces 126, 134 and the first and second length portions 146, 148 are heated, by induction heating. The first length portion 146 is a portion of the first rail 122, adjacent to the first end face 126, that is heated to the predetermined hot working temperature. The second length portion 148 is a portion of the second rail 128, adjacent to the second end face 134, that is heated to the predetermined hot working temperature.

It will be understood that the first and second length portions 146, 148 are schematically represented in FIG. 2B. For illustrative purposes, the first and second length portions 146, 148 are shown in FIG. 2B as extending uniform distances from the first and second end faces 126, 134 into the first and second rails 122, 128 respectively. However, those skilled in the art would appreciate that the distribution of heat energy from the heating elements 140 in the first and second rails 122, 128 may not, in practice, be uniform relative to the first and second end faces 126, 134. Also, and as will be described, preheating of the heads 123, 130 may be needed in order to provide heated portions that are substantially uniformly heated.

It is preferred that one or more of the first and second rails 122, 128 is subjected to transverse motion thereof in at least one direction that is at least partially transverse to the first and second rail center lines 124, 132. In FIGS. 2B and 2C, as examples, directions of motion of the first rail 122 that are generally transverse to the first rail center line 124 are indicated by arrows “A₁” and “A₂” respectively. Directions of motion of the second rail 128 that are generally transverse to the second rail center line 132 are indicated by arrows “B₁” and “B₂” respectively.

It will also be understood that the transverse directions generally indicated by arrows “A₁”, “A₂”, “B₁”, and “B₂” are exemplary only. It will be understood that the transverse motion may be in any direction relative to the center lines 124, 132, and may be at least partially nonlinear. It will be understood that the transverse motion may be repetitive, and the transverse motion may be at any suitable frequency and directions.

As soon as the first end face 126 and the first length portion 146 and the second end face 134 and the second length portion 148 are at the predetermined hot working temperature, the heating elements 140 preferably are removed from the opening 138. It will be understood that the cover 144 may also be removed once the heating elements 140 are de-energized, and the non-oxidizing atmosphere may be allowed to diffuse into the ambient atmosphere. The heating elements 140 may be de-energized after their removal.

While one or more of the first and second rails 122, 128 are subjected to the transverse motion, and while the first end face 126 and the first length portion 146 and the second end face 134 and the second length portion 148 are at the predetermined hot working temperature, the first and second end faces 126, 134 preferably are engaged with each other, to at least partially plastically deform the first and second end faces 126, 134 and the first and second length portions 146, 148. As a result, the first and second end faces 126, 134 and the first and second length portions 146, 148 are at least partially fused together to form the fused rail assembly 120, as will be described. The first end face 126, the first length portion 146, the second rail face 134, and the second length portion 148 are sometimes collectively or individually herein referred to as heated portions.

As can be seen in FIG. 2D, in one embodiment, the first and second rails preferably are moved toward each other (in the directions indicated by arrows “J” and “K”, to push the first and second end faces 126, 134 against each other. As described above, in one embodiment, the transverse motion of one or both of the rails 122, 128 preferably commences before the first and second end faces 126, 134 engage each other.

It will be understood that, if preferred, the transverse motion of one or both of the first and second rails 122, 128 may alternatively commence after the first and second ends 126, 134 have been engaged with each other.

The transverse motion of one or both of the rails 122, 128 while the first and second end faces 126, 134 are engaged with each other and at the predetermined hot working temperature results in the shearing of at least part of the material that is in the heated portions, at the predetermined hot working temperature. In practice, after the removal of the heating element 140, the temperature of such material rapidly falls. Accordingly, the first and second end faces 126, 134 are promptly engaged with each other, and pushed against each other, shortly after the heating elements 140 are de-energized and removed. Further plastic deformation after the temperature of the material in the heated portions has fallen below the hot working temperature is then no longer feasible. At that point, transverse motion of one or more of the rails 122, 128 relative to the center lines 124, 132 thereof ceases.

Preferably, the fused rail assembly is cooled (or allowed to cool), to an ambient temperature.

Once the fused rail assembly 120 has been formed, the material in the heated portions thereof that had been heated to the predetermined hot working temperature and subjected to shearing has a generally uniform fine-grained microstructure. The microstructure is substantially consistent throughout the formerly heated portions of the fused rail assembly 120, i.e., the portions thereof that had been heated to the predetermined hot working temperature and subjected to shearing, and there are no heat-affected zones therein, providing a uniformly strong fused rail assembly 120 throughout.

The fused rail assembly 120 does not include a heat-affected zone, with weakened or softened regions, because the material in the heated portion is only heated to the predetermined hot working temperature, that is, such material is not heated to its melting temperature.

It has been determined that most of the energy consumed in the method of the invention, i.e., approximately 98 percent, is the electrical energy provided to the heating elements. The balance of the energy consumed is utilized in generating the transverse motion, and in engaging the first and second rails with each other.

In one embodiment, after the heating elements are de-energized and withdrawn, the heads 123, 130 preferably are only lightly engaged with each other, and upon such engagement, one or both of the rails 122, 128 are subjected to transverse motion thereof, until further transverse motion is not feasible.

It will also be understood that only minimal force is used to engage the first and second ends 126, 134. This has been found, surprisingly, to provide better results than forceful engagement. It is believed that better results are achieved with less engagement or forging force because applying the lower engagement (compression) force permits more thorough shearing of the heated portions to take place, while the first and second end faces 126, 134 are engaged.

The induction coils of the heating elements may be energized at different times, and at different rates.

As will be described, due to the cross-sectional shape of the rails 122, 128, with the rail heads 123, 130 being thicker than the web and the foot, it is preferred that the first and second end faces 126, 134 at the respective heads 123, 130 are pre-heated.

As described above, while the material in the heated portions is at the predetermined hot working temperature, and when the first and second end faces 126, 134 are pushed against each other, such material is plastically deformed. Those skilled in the art would appreciate that, once the fused rail assembly 120 has been formed, some of the material of the previously heated portions may extend outwardly, e.g., beyond the first and second rail heads 123, 130. In effect, some of the material in the heated portions may be squeezed outwardly, when the first and second end faces 126, 134 are engaged with each other. As an example, excess top and side material 150, 152 is illustrated in FIGS. 2E and 2F.

It will be understood that the fused rail assembly 120 without any excess material thereon is illustrated in FIG. 2D. In FIGS. 2E and 2F, it can be seen that the excess material includes the excess top material 150 and the excess side material 152. It will also be understood that the fused rail assembly 120 illustrated in FIG. 2D is the finished fused rail assembly 120, produced by removing such excess top and side material 150, 152 as there may be, as will be described. Those skilled in the art would be aware of suitable finishing processes that may be utilized to achieve this result.

Although the method of the invention does not produce a joint or weld interface, a dashed line “X” in FIG. 2D indicates the location at which the first and second end faces 126, 134 engage each other.

In FIG. 2F, an outline of a design profile “D” is provided in solid outline, and the excess top and side material 150, 152 is illustrated in ghost or dashed outline. Those skilled in the art would appreciate that the design profile “D” is the same for both of the first and second rail heads 123, 130. It will be understood that the extent of the excess top material 150 and the extent of the excess side material 152 has been exaggerated in FIG. 2F, for illustrative purposes. There may also be material extruded beyond the design profile “D” in the vicinity of the web “W” and the foot “Z”, however, such material is omitted from FIG. 2F for clarity of illustration. Those skilled in the art would appreciate that any extruded material in the vicinity of the web “W” or the foot “Z” may in general be allowed to remain in place. If necessary, however, any extruded material in the vicinity of the web “W” and the foot “Z” may be removed using the finishing processes, referred to below.

Preferably, the excess top material 150 and the excess side material 152 is to be removed so that, where the first and second end faces 126, 134 are fused together, the first and second heads 123, 130 are horizontally (or substantially horizontally) aligned (FIG. 2D). The design profile “D” includes a crown portion “C” and field and gauge corners “FC”, “GC” adjacent to the crown portion “C” of the design profile (FIG. 2F). As can be seen in FIG. 2F, the excess top portion 150 is positioned adjacent to the crown portion “C” and the field and gauge corners “FC”, “GC”.

The design profile “D” also includes a field face “FF” extending downwardly from the field corner “FC”, and a gauge face “GF” extending downwardly from the gauge corner “GC”. The design profile “D” also includes upper fishing surfaces “UF” located adjacent to the field and gauge faces “FF”, “GF”. As can be seen in FIG. 2F, the excess side material 152 is positioned adjacent to the field and gauge faces “FF”, “GF” and the upper fishing surfaces “UF”.

Preferably, the excess top material 150 (FIGS. 2E, 2F) on respective head top surfaces 154A, 154B (FIG. 2E) of the first and second rail heads 123, 130 of the fused rail assembly 120 is subjected to one or more finishing processes, to remove the excess top material 150 for aligning the respective head top surfaces 154A, 154B with each other. It is also preferred that the excess side material 152 (FIGS. 2E, 2F) on respective field and gauge head sides 156A, 156B and 158A, 158B (FIG. 2C) of the first and second rail heads 123, 130 of the fused rail assembly 120 is subjected to the one or more finishing processes, to remove the excess side material 152 for aligning the field head sides 156A, 156B of the first and second rail heads 123, 130 with each other, and to align the gauge head sides 158A, 158B of the first and second rail heads 123, 130 with each other.

It will be understood that, as can be seen in FIG. 2F, the respective head top surfaces 154A, 154B include the crown portion “C” and the field and gauge corners “FC”, “GC”. It will also be understood that the finishing processes may be used to remove the excess top material 150. Accordingly, removal of the excess top material 150 exposes the crown portion “C” and the field and gauge corners “FC”, “GC” of each of the respective head top surfaces 154A, 154B.

Similarly, the field head sides 156A, 156B (FIG. 2C) each include the field face “FF” and the upper fishing surfaces “UF” adjacent thereto. Accordingly, removal of the excess side material 152 on the field side “F” of the first and second rail heads 123, 130 exposes the field face “FF” and the adjacent upper fishing surface “UF” of each of the field head sides 156A, 156B. The gauge head sides 158A, 158B (FIG. 2C) each include the gauge face “GF” and the upper fishing surfaces “UF” adjacent thereto. Accordingly, removal of the excess side material 152 on the gauge side “G” of the first and second rail heads 123, 130 exposes the gauge face “GF” and the adjacent upper fishing surface “UF” of each of the gauge head sides 158A, 158B.

As can be seen in FIGS. 2E and 2F, the excess top material 150 may be removed to expose the respective head top surfaces 154A, 154B of the first and second rail heads 123, 130. In addition, the excess side material 152 may be removed to expose the respective field and gauge head sides 156A, 156B and 158A, 158B of the first and second rail heads 123, 130.

From the foregoing, it can be seen that, in the process of the invention, it is preferred that the heated portions of the rails 122, 128 extend a substantially uniform distance into the first and second rails 122, 128. The first and second heads 123, 130 of the first and second rails 122, 128 (FIG. 2C) have relatively thick cross-sectional areas, compared to the cross-sectional areas of the respective webs 116A, 116B and feet 114A, 114B thereof (FIG. 2E). Those skilled in the art would appreciate that, due to the larger cross-sectional areas of the heads 123, 130, additional heat may be directed over time toward the heads 123, 130 at the first and second end faces 126, 134, in order to provide sufficient heat, so that the first and second length portions 146, 148 may extend into the first and second rails 122, 128 the same distance (or approximately the same distance) from the first and second end faces 126, 136 respectively.

It will be understood that, as noted above, the heating elements heat the heated portions to the predetermined hot working temperature. In the method of the invention, the heated portions are not heated to a temperature above the hot working temperature, i.e., a melting temperature. Accordingly, in order to provide generally uniformly heated heated portions, it is preferred that the heads are pre-heated, to provide heat to the head portions to a greater extent over time.

In one embodiment, the first length portion 146 preferably includes a first central region 160A that is aligned with a first central head area 162A of the first end face 126 and a first outer region 164A that is adjacent to the first central region 160A (FIG. 2B). It is also preferred that the second length portion 148 comprises a second central region 160B that is aligned with a second central head area 162B of the second end face 134 and a second outer region 164B that is adjacent to the second central region 162B. Preferably, the first central region 160A and the second central region 160B are both heated by the heating element(s) 140 to a greater extent over time than the first and second outer regions 164A, 164B.

Those skilled in the art would appreciate that the first and second central regions 160A, 160B may be subjected to heat to a greater extent over time than the first and second outer regions 164A, 164B by utilizing any suitable devices and methods. As noted above, this is preferably achieved by pre-heating the first and second central regions 160A, 160B. For example, the heating elements 140 that are positioned proximal to the first and second central head areas 162A, 162B may be configured to provide heat to the first and second central regions 160A, 160B for a predetermined preheat time period before the heating elements 140 that are positioned for heating the first and second outer regions 164A, 164B are energized. Also, the heating elements 140 that are proximal to the first and second central head areas 162A, 162B may be configured to provide heat at a faster rate than the heating elements 140 that are positioned for heating the first and second outer regions 164A, 164B.

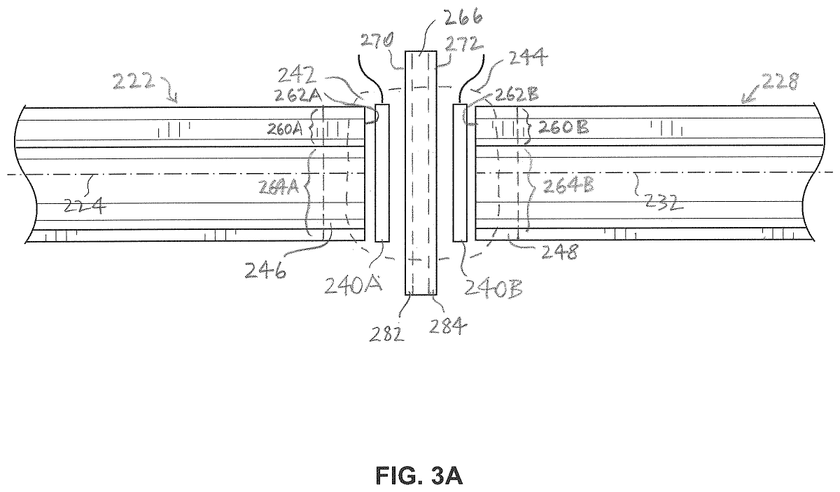

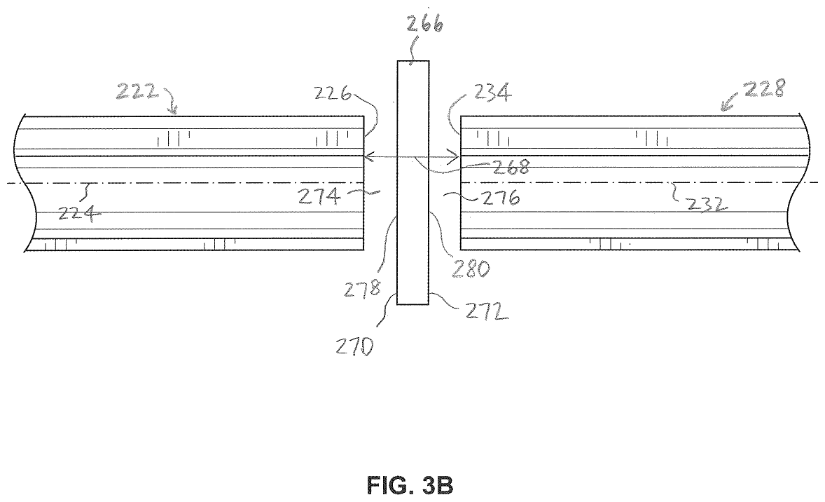

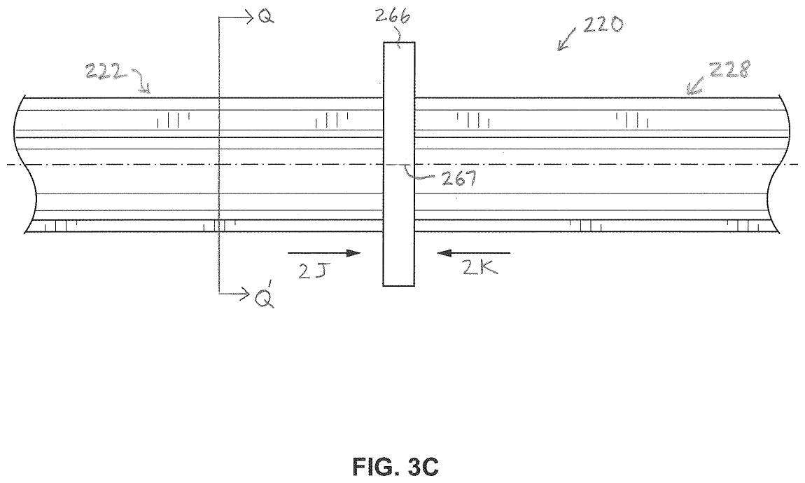

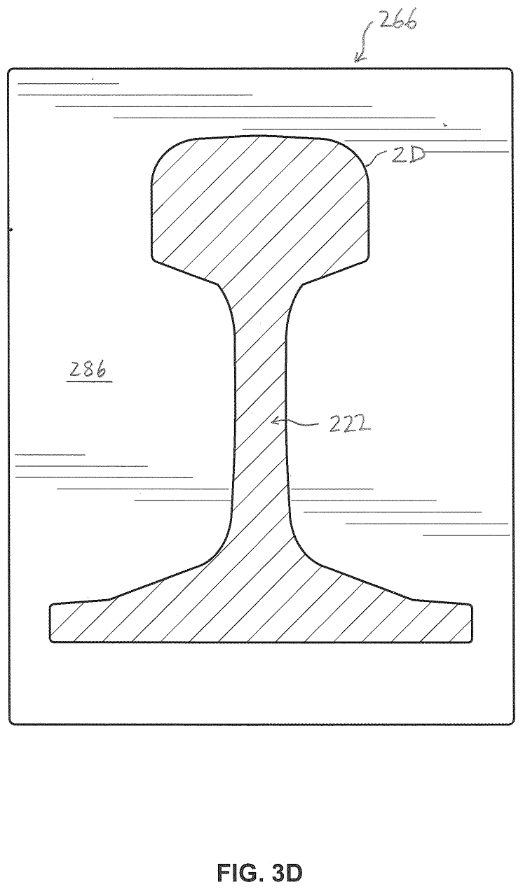

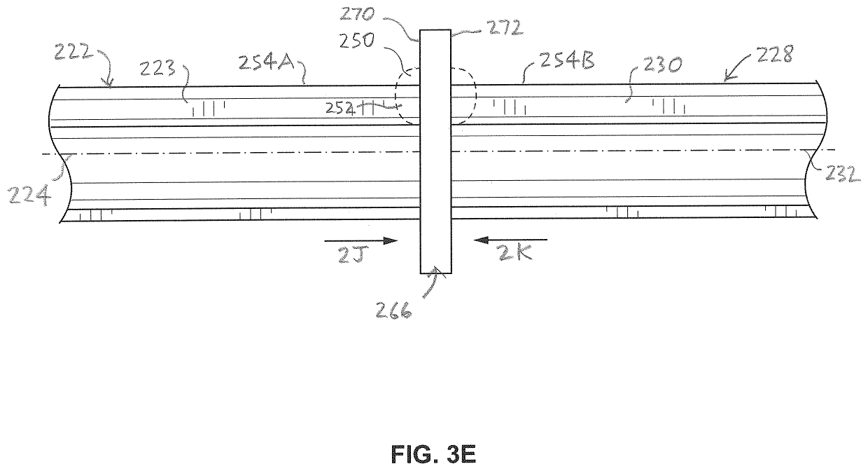

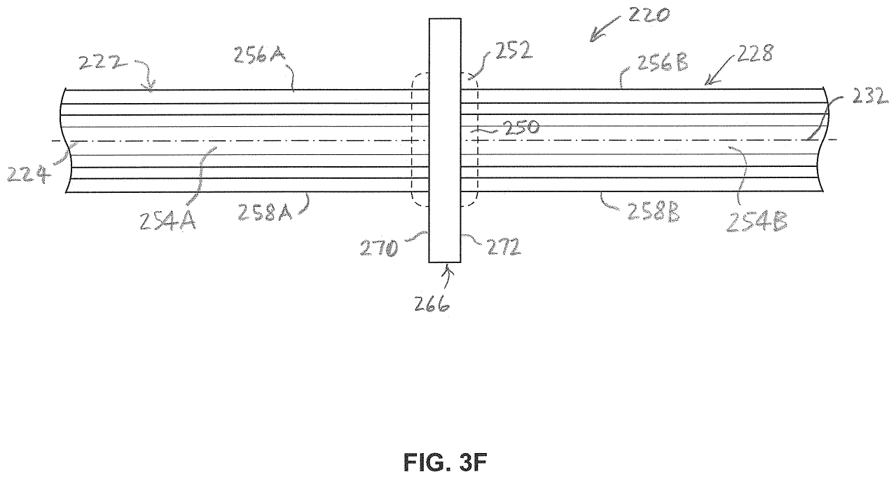

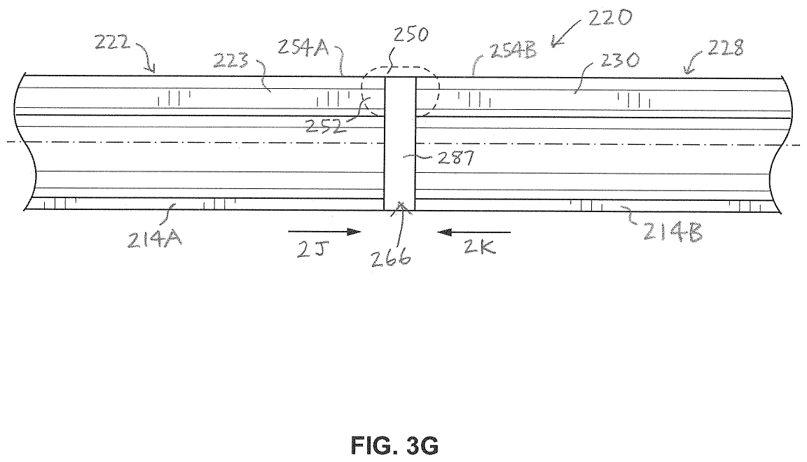

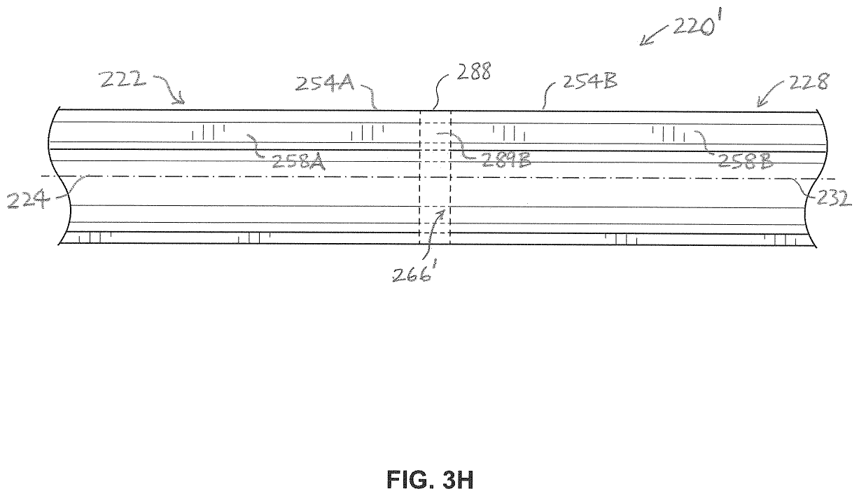

Another embodiment of the method of the invention is illustrated in FIGS. 3A-3H. In this embodiment, an intermediate element 266 is provided, and the method of the invention may be utilized, e.g., where transverse movement of one or both of first and second rails 222, 228 is inconvenient, or not feasible. Preferably, the first and second rails 222, 228 are positioned to locate first and second end faces 226, 234 facing each other and to align first and second rail center lines 224, 232 (FIG. 3A). It is preferred that the first and second end faces 226, 234 are spaced apart from each other by a predetermined distance 268 (FIG. 3B) to define an opening between the first and second end faces 226, 234. As can be seen in FIGS. 3A and 3B, the intermediate element 266 preferably includes first and second sides 270, 272 thereof.

Preferably, the intermediate element 266 is positioned in the opening between the first and second end faces 226, 234, to define a first gap 274 between the first end face 226 and the first side 270, and to define a second gap 276 between the second end face 234 and the second side 272 (FIG. 3B). The first and second sides 270, 272 respectively include first and second contact surfaces 278, 280, for engagement with the first and second end faces 226, 234 respectively. Preferably, one or more first heating elements 240A are positioned in the first gap 274, and one or more second heating elements 240B are positioned in the second gap 276 (FIG. 3A). It will be understood that the heating elements 240A, 240B are omitted from FIG. 3B for clarity of illustration.

The intermediate element defines an intermediate element center line 267 thereof (FIG. 3C). It is preferred that the intermediate element center line 267 is aligned with the first and second rail center lines 224, 232.

It will also be understood that a non-oxidizing atmosphere is provided, covering the first and second end faces 226, 234 and the first and second contact surfaces 278, 280. The region covered by the non-oxidizing atmosphere is identified by reference numeral 242 in FIG. 3A. A cover 244 for containing the non-oxidizing atmosphere is schematically represented in FIG. 3A.

Next, the first heating element(s) 240A preferably are energized, to heat the first end face 226 and a first length portion 246 of the first rail 222 extending from the first end face 226 into the first rail 222 to a predetermined hot working temperature, at which the first end face 226 and the first length portion 246 are plastically deformable. When the first heating element 240A is energized, the first contact surface 278 and a first intermediate element portion 282 of the intermediate element 266 extending from the first contact surface 278 into the intermediate element 266 are heated to the predetermined hot working temperature, at which the first contact surface 278 and the first intermediate element portion 282 are plastically deformable.

The second heating element(s) 240B preferably are also energized, to heat the second end face 234 and a second length portion 248 of the second rail 288 extending from the second end face 234 into the second rail 228 to the predetermined hot working temperature, at which the second end face 234 and the second length portion 248 are plastically deformable. When the second heating element 240B is energized, the second contact surface 280 and a second intermediate element portion 284 of the intermediate element 266 extending from the second contact surface 280 into the intermediate element 266 are heated to the predetermined hot working temperature, at which the second contact surface 280 and the second intermediate element portion 284 are plastically deformable.

The intermediate element 266 may be utilized to join two rails 222, 228 that are made of different material, which may be difficult to join together directly. In these circumstances, for example, the first rail 222 may preferably be heated to a first predetermined hot working temperature, and the second rail 228 may be preferably heated to a different second predetermined hot working temperature. The intermediate element 266 is compatible with the first and second predetermined hot working temperatures. The first heating elements 240A may heat the first end face 226, the first length portion 246, the first contact surface 278, and the first intermediate element portion 282 to the first predetermined hot working temperature. The second heating elements 240B may heat the second end face 234, the second length portion 248, the second contact surface 280, and the second intermediate element portion 284 to the second predetermined hot working temperature.

Various techniques may be utilized to heat the two rails 222, 228 to different temperatures. For example, the gaps 274, 276 may be different widths. Alternatively, or in addition, the heating elements 240A, 240B may be positioned differently relative to the first and second rails 222, 228. The heating elements 240A, 240B may be configured to provide different amounts of heat energy, and they may also provide heat energy over different time periods. For instance, the heating elements 240A, 240B may heat over different preheat periods.

It will be understood that all of the first and second length portions 246, 248 and the first and second intermediate element portions 282, 284 are schematically represented in FIG. 3A. For illustrative purposes, the first and second length portions 246, 248 are shown in FIG. 3A as extending uniform distances from the first and second end faces 226, 234 into the first and second rails 222, 228. However, those skilled in the art would appreciate that the distribution of heat energy from the heating elements 240A, 240B in the first and second rails 222, 228 may not, in practice, be uniform relative to the first and second end faces 226, 234.

In one embodiment, one or both of the first and second rails 222, 228 preferably are subjected to transverse motion in at least one direction that is at least partially transverse to the first and second rail center lines 224, 232. As described above, the transverse motion of the rails 222, 228 may be in any direction that is transverse to the center lines thereof.

While one or both of the first and second rails 222, 228 are subjected to transverse motion, and while the first end face 226, the first length portion 246, the first contact surface 278, the first intermediate element portion 282, the second end face 234, the second length portion 248, the second contact surface 280, and the second intermediate element portion 284 are at the predetermined hot working temperature, the first and second end faces 226, 234 are engaged with the first and second contact surfaces 278, 280 respectively, to at least partially plastically deform the first end face 226, the first length portion 246, the first contact surface 278, and the first intermediate element portion 282, and to at least partially plastically deform the second end face 234, the second length portion 248, the second contact face 280, and the second intermediate element portion 284. Due to such plastic deformation, the first end face 226, the first length portion 246, the first contact surface 278, and the first intermediate element portion 282, are fused together, as will be described. In addition, and also due to such plastic deformation, the second end face 234, the second length portion 248, the second contact surface 280, and the second intermediate element portion 284 are fused together, to form a fused rail assembly 220 (FIG. 3C). The first end face 226, the first length portion 246, the first contact surface 278, the first intermediate element portion 282, the second rail face 234, the second length portion 248, the second contact surface 280, and the second intermediate element portion 284 are sometimes collectively or individually herein referred to as heated portions.

The first rail 222 preferably is moved in the direction indicated by arrow “2J” in FIG. 3C, to push the first end face 226 against the first contact surface 278. At approximately the same time, the second rail 228 preferably is moved in the direction indicated by arrow “2K” in FIG. 3C, to push the second end face 234 against the second contact surface 280. As noted above, it is preferred that the engagement is effected with minimal compressive force.

In one embodiment, the intermediate element 266 may be subjected to transverse motion in one or more intermediate element directions that are at least partially transverse to the intermediate element center line 267. Such transverse motion moves the intermediate element 266 relative to the first and second end faces 226, 234. Like the transverse motion of the rails 222, 228 relative to the center lines thereof, the transverse motion of the intermediate element 266 may be in any directions that are transverse to the intermediate element center line 267.

In one embodiment, the rails 222, 228 and the intermediate element 266 may all be subjected to respective transverse motions thereof while the heated portions are at the predetermined hot working temperature, and while the first and second end faces 226, 234 are engaged with the first and second contact surfaces 278, 280. The transverse motion may commence before or after such engagement.

In another embodiment, only the rails 222, 228 may be subjected to transverse motion thereof while the engagement of the first and second end faces 226, 234 with the first and second contact surfaces 278, 280 takes place. The transverse motion may commence before or after such engagement.

In yet another alternative embodiment, only the intermediate element 266 is subjected to transverse motion relative to the intermediate element center line 267 while the engagement of the first and second end faces 226, 234 with the first and second contact surfaces 278, 280 takes place. The transverse motion may commence before or after such engagement.

In one embodiment, after the fused rail assembly 220 is formed, the fused rail assembly 220 preferably is cooled or allowed to cool to an ambient temperature.

It will be understood that, once the fused rail assembly 220 has been formed, some of the material of the previously heated portions may extend outwardly, e.g., beyond the first and second rail heads 223, 230. As can be seen in FIGS. 3E and 3F, as an example, excess top material 250 and excess side material 252 may be positioned adjacent to the first and second sides 270, 272 of the intermediate element 266. Those skilled in the art would appreciate that some or all of the excess top material 250 and the excess side material 252 may be required to be removed, to provide a modified fused rail assembly 220′. Such removal may be required in order to ensure that respective head top surfaces 254A, 254B of the first and second rail heads 223, 230 of the fused rail assembly 220 are aligned, and also to ensure that respective field and gauge head sides 256A, 258A, 256B, 258B of the rail heads 223, 230 of the fused rail assembly 220′ are aligned, to permit wheels of railway vehicles to roll unobstructed over the fused rail assembly 220′. Those skilled in the art would also be aware of suitable finishing processes that may be utilized, for removal of the excess top material 250 and the excess side material. It will be understood that the fused rail assembly 220 as illustrated in FIG. 3C shows the fused rail assembly after the excess top material 250 and the excess side material has been removed. As will be described, the complete or modified fused rail assembly 220′ that is produced after further finishing processes are applied is illustrated in FIG. 3H.

Preferably, the excess top material 250 on respective head top surfaces 254A, 254B of the first and second rail heads 223, 230 of the fused rail assembly 220 is subjected to one or more finishing processes, to remove the excess top material 250 for aligning the respective head top surfaces 254A, 254B with each other. It is also preferred that excess side material 252 on the respective field and gauge head sides 256A, 258A, 256B, 258B of the first and second rail heads 223, 230 of the fused rail assembly 220 is subjected to the finishing processes, to remove the excess side material 252 for aligning the field head sides 256A, 256B of the first and second rail heads 223, 230 with each other, and to align the gauge head sides 258A, 258B of the first and second rail heads 223, 230 with each other.

It will be understood that FIG. 3D is a cross-section of the fused rail assembly taken at Q-Q′ in FIG. 3C. For clarity of illustration, the excess top material 250 and the excess side material 252 are omitted from FIGS. 3C and 3D. The first rail 222 has a design profile “2D” (FIG. 3D). It will be understood that the second rail 228 has a profile that is the same as that of the first rail 222, and the first and second rails 222, 228 preferably are horizontally aligned. As can be seen in FIG. 3D, in one embodiment, the intermediate element 266 preferably includes a plate portion 286 that extends outwardly relative to the rails 222, 228 once the fused rail assembly 220 is formed. The size of the plate portion 286 as illustrated in FIG. 3D is exaggerated, for clarity of illustration.

It will be understood that the intermediate element 266 may be provided without a plate portion thereof. The plate portion 286 may be included in the intermediate element 266, for instance, to facilitate positioning the intermediate element relative to the first and second rails 222, 228. Also, the plate portion 286 may be used to facilitate transverse movement of the intermediate element 266. For example, one or more devices (not shown) for holding the intermediate element 266 in position, and/or for subjecting the intermediate element 266 to transverse motion, may engage the plate portion 286.

It will also be understood that the intermediate element 266 may include a plate portion that is smaller than the plate portion 286. For example, in FIG. 3G, an intermediate element 266_{A} is shown that includes a shortened plate portion 287 that does not extend upwardly past the head top surfaces 254A, 254B or below the feet 214A, 214B of the first and second rails 222, 228. It will be understood that the plate portion 287 extends horizontally from the sides of the first and second rails 222, 228 once the fused rail assembly 220 has been formed (FIG. 3G). In this embodiment, the plate portion 287 facilitates holding the intermediate element 266 in position and (if necessary) subjecting the intermediate element 266 to transverse motion while the fused rail assembly 220 is formed, by providing surfaces engageable by devices (not shown) to locate and/or move the intermediate element 266 as required.

As can be seen in FIG. 3G, once the first and second rails 222, 228 have been engaged during transverse motion of one or more of the intermediate element 266 and the first and second rails 222, 228, excess top material 250 and excess side material 252 may be extruded outwardly. As illustrated in FIG. 3G, the amount of the excess top material 250 and the excess side material 252 is exaggerated for clarity of illustration.

Preferably, the plate portion 286 of the intermediate element 266 of the fused rail assembly is subjected to one or more finishing processes to provide a modified intermediate element 266′ (FIG. 3H) that includes an intermediate element head top surface 288 aligned with the head top surfaces 254A, 254B of the first and second rails 222, 228. It is also preferred that the plate portion 286 is further subjected to the finishing processes, so that the modified intermediate element 266′ includes respective field and gauge intermediate element head sides. The field intermediate element head side (not shown in FIG. 3H) preferably is aligned with the field head sides 256A, 256B of the first and second rail heads 223, 230, and the gauge intermediate element head side 289B (FIG. 3H) preferably is aligned with the gauge head sides 258A, 258B of the first and second rail heads 223, 230. Those skilled in the art would be aware of suitable finishing processes.

As can be seen in FIG. 3H, the plate portion 286 preferably is removed, and the balance of the intermediate element 266 remaining is the modified intermediate element 266′. The modified intermediate element 266′ preferably has a profile thereof that is aligned with the profiles of the first and second rails 222, 228, to permit rail wheels to roll over the first and second rails 222, 228 and the balance of the intermediate element 266. As noted above, the completed fused rail assembly shown that has been subjected to the finishing processes is shown in FIG. 3H and is identified by reference character 220′.

Those skilled in the art would appreciate that the intermediate element 266 that is shown in FIG. 3G may also be subjected to finishing processes to remove the plate portion 287 thereof and to remove the excess top material 250 and the excess side material 252, to provide the modified intermediate element 266′ that is shown in FIG. 3H.

In one embodiment, the first length portion 246 includes a first central region 260A that is aligned with a first central head area 262A of the first rail head 223 and a first outer region 264A that is adjacent to the first central region 260A. Preferably, the second length portion 248 includes a second central region 260A that is aligned with a second central head area 262B of the second rail head 230 and a second outer region 264B that is adjacent to the second central region 260B. It is also preferred that the first central region 260A and the second central region 260B are heated by the first heating element 240A and heated by the second heating element 240B respectively to a greater extent over time than the first and second outer regions 264A, 264B.

As noted above, it is advantageous to provide more heat to the head portions 223, 230 over time, in order to achieve a generally uniform heat distribution in the heated portions. This may be effected by preheating the head portions 223, 230.

Those skilled in the art would appreciate that the first and second central regions 260A, 260B may be subjected to greater heat over time than the first and second outer regions 264A, 264B by utilizing any suitable devices and methods. For example, the heating elements 240A, 240B that are respectively positioned proximal to the first and second central head areas 262A, 262B may be configured to provide more heat over time to the first and second central regions 260A, 260B than the heating elements 240A, 240B that are positioned for heating the first and second outer regions 264A, 264B.

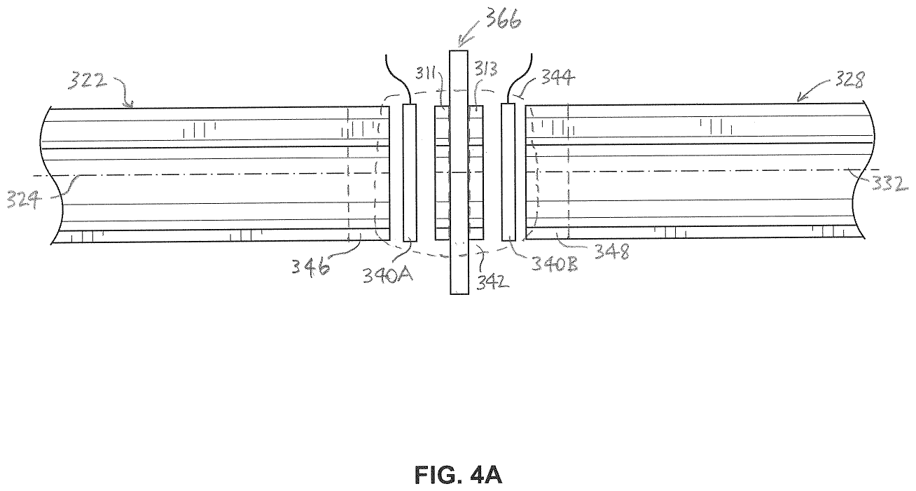

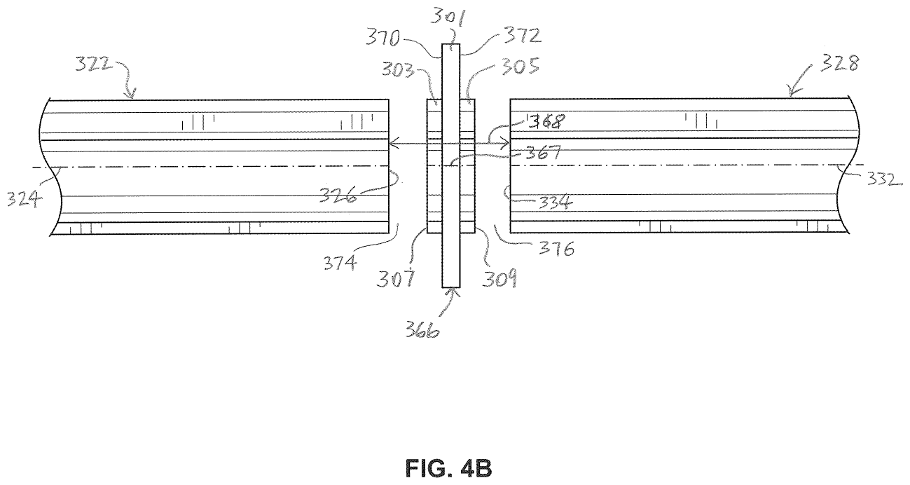

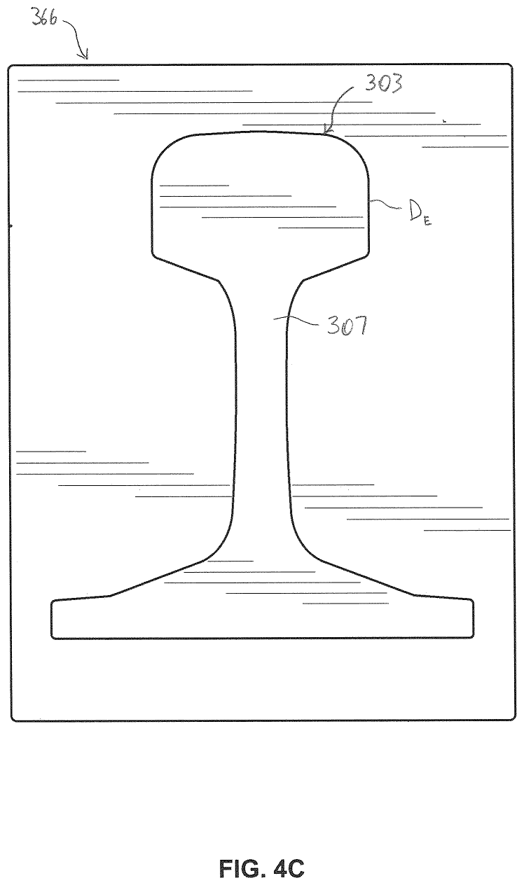

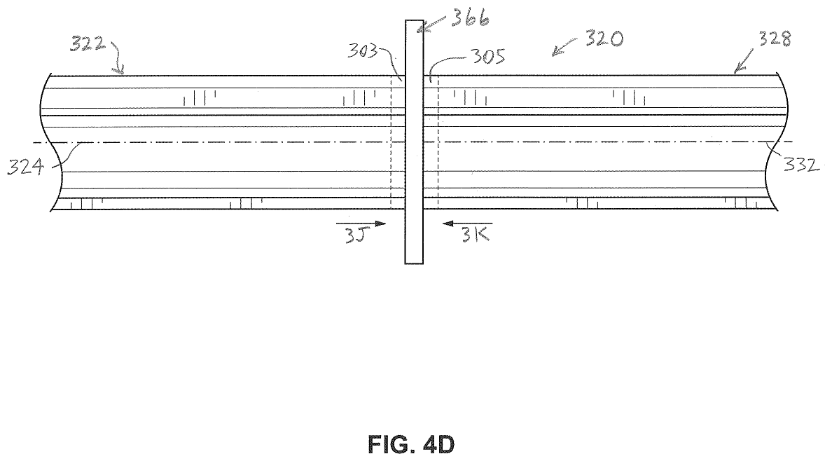

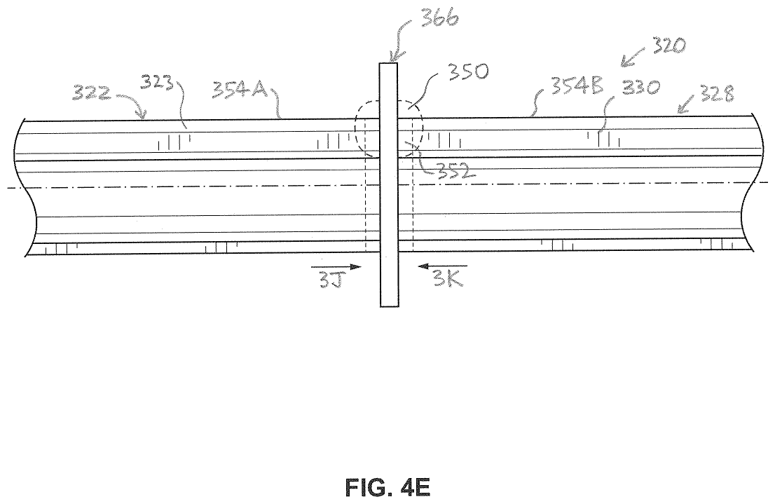

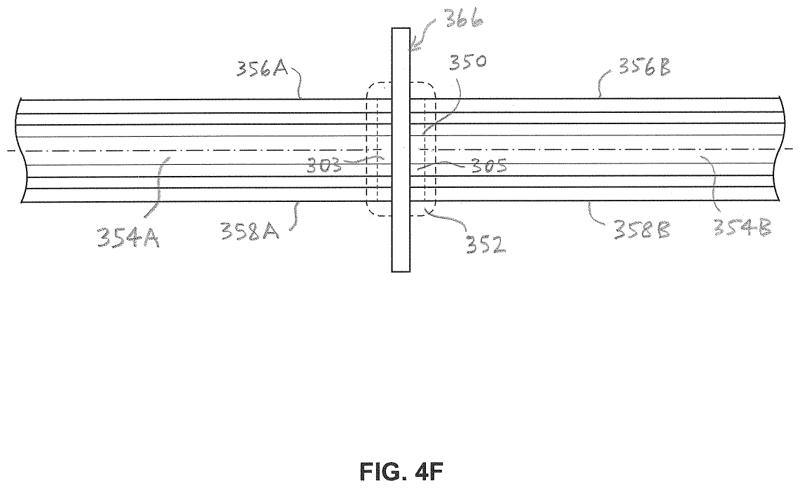

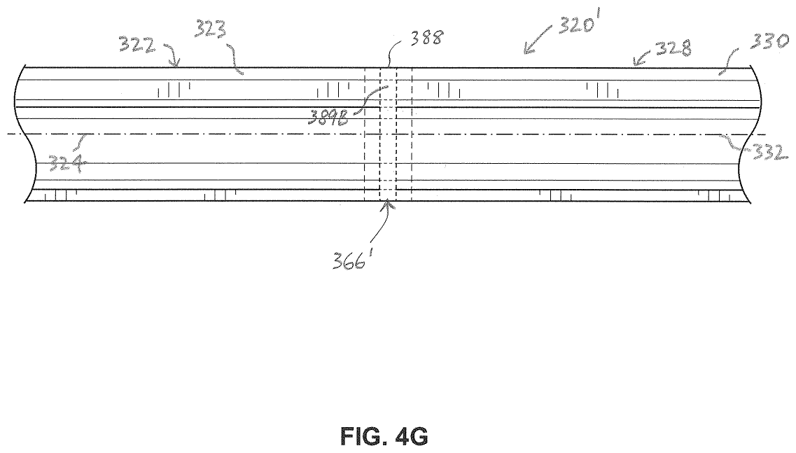

An alternative method of forming the fused rail assembly 320 of the invention is illustrated in FIGS. 4A-4G. Preferably, a first rail 322 and a second rail 328 are provided, and positioned to locate first and second end faces 326, 334 thereof facing each other and spaced apart from each other by a predetermined distance 368 to define an opening between the first and second end faces 326, 334 (FIG. 4B).

As can be seen in FIG. 4B, an intermediate element 366 preferably is provided that includes a body 301 having first and second sides 370, 372 thereof. It is also preferred that the intermediate element 366 additionally includes first and second extension portions 303, 305 thereof that extend in opposite directions from the first and second sides 370, 372 to define respective first and second extension faces 307, 309 thereof. Preferably, the intermediate element 366 is positioned in the opening between the first and second end faces 326, 334, to define a first gap 374 between the first end face 326 and the first extension face 307 of the intermediate element 366, and to define a second gap 376 between the second end face 334 and the second extension face 309 of the intermediate element 366.

As noted above, the intermediate element may be used to join (via the intermediate element) rails of dissimilar materials.

The intermediate element 366 defines an intermediate element center line 367 thereof that preferably is aligned with respective center lines 324, 332 of the first and second rails 322, 328 when the intermediate element 366 is positioned between the first and second rails 322, 328.

One or more first heating elements 340A preferably are positioned in the first gap 374, and one or more second heating elements 340B are positioned in the second gap 376.

It will also be understood that a non-oxidizing atmosphere preferably is provided, covering the first and second end faces 326, 334 and the first and second extension faces 307, 309. The region covered by the non-oxidizing atmosphere is identified by reference numeral 342 in FIG. 4A. A cover 344 for containing the non-oxidizing atmosphere is schematically represented in FIG. 4A.

Next, the first heating elements 340A are energized, to heat the first end face 326 and a first length portion 346 of the first rail 322 extending from the first end face 326 into the first rail 322 to a predetermined hot working temperature, at which the first end face 326 and the first length portion 346 are plastically deformable (FIG. 4A). The first heating elements 340A also heat the first extension face 307 and a first intermediate element portion 311 of the intermediate element 366 extending from the first extension face 307 into the intermediate element 366 to the predetermined hot working temperature, at which the first extension face 307 and the first intermediate element portion 311 are plastically deformable.

Preferably, the second heating elements 340B are also energized, to heat the second end face 334 and a second length portion 348 of the second rail 328 extending from the second end face 334 into the second rail 328 to the predetermined hot working temperature, at which the second end face 334 and the second length portion 348 are plastically deformable (FIG. 4A). The second heating elements 340B also heat the second extension face 309 and a second intermediate element portion 313 of the intermediate element 366 extending from the second extension face 309 into the intermediate element 366 to the predetermined hot working temperature, at which the second extension face 309 and the second intermediate element portion 313 are plastically deformable.

In one embodiment, the intermediate element 366 preferably is subjected to transverse motion in one or more directions that are at least partially transverse to the intermediate element center line 367.

Preferably, while the intermediate element 366 is subjected to transverse motion thereof, and also while the first end face 326, the first length portion 346, the first extension face 307, the first intermediate element portion 311, the second end face 334, the second length portion 348, the second extension face 309, and the second intermediate element portion 313 are at the predetermined hot working temperature, the first and second end faces 326, 334 are engaged with the first and second extension faces 307, 309 respectively, to at least partially plastically deform the first end face 326, the first length portion 347, the first extension face 307, the first intermediate element portion 311, and also to at least partially plastically deform the second end face 334, the second length portion 348, the second extension face 309, and the second intermediate element portion 313.

Due to such plastic deformation, the first end face 326, the first length portion 346, the first extension face 307, and the first intermediate element portion 311 are fused together. In addition, and also due to such plastic deformation, the second end face 334, the second length portion 348, the second extension face 309, and the second intermediate element portion 313 are fused together, to form the fused rail assembly 320. The first end face 326, the first length portion 346, the first extension face 307, the first intermediate element portion 311, the second rail face 334, the second length portion 348, the second extension face 309, and the second intermediate element portion 313 are sometimes collectively or individually herein referred to as heated portions.

Preferably, the first rail 322 is moved in the direction indicated by arrow “3J” in FIG. 4D, to push the first end face 326 against the first extension face 307. At approximately the same time, the second rail 328 preferably is moved in the direction indicated by arrow “3K” in FIG. 4C, to push the second end face 334 against the second extension face 309.

In one embodiment, the rails 322, 328 and the intermediate element 366 may all be subjected to respective transverse motions thereof while the heated portions are at the predetermined hot working temperature, and while the first and second end faces 226, 234 are engaged with the first and second contact surfaces 278, 280. The first and second rails 322, 328 may be subjected to transverse motion thereof relative to their respective center lines 324, 332. Alternatively, the rails 322, 328 may be subjected to transverse motions relative to their respective center lines 324, 332 alone, i.e., while the intermediate element 366 is stationary. The transverse motion of any of the elements may commence before or after engagement of the rails 322, 328 with the intermediate element 366.

As can be seen in FIG. 4C, the first extension face 307 of the first extension portion 303 preferably is shaped to have a design profile “D_{E}” that is the same as the design profile of the first rail 322, with which it becomes fused. It will be understood that the second extension face 309 also has a design profile (not shown) that is the same as the design profile of the second rail 328. Those skilled in the art would appreciate that the design profiles of the first and second rails 322, 328, and those of the first and second extension faces 307, 309, preferably are all the same. The intermediate element 366 may include a plate portion 386.

It will be understood that the intermediate element 366 may be provided without a plate portion thereof. The plate portion 386 may be included in the intermediate element 266, for instance, to facilitate positioning the intermediate element relative to the first and second rails 322, 328. Also, the plate portion 386 may be used to facilitate transverse movement of the intermediate element 366. If the intermediate element 366 includes a plate portion 366, then the plate portion 386 is at least partially removed by utilizing finishing processes as will be described.

Once the fused rail assembly 320 has been subjected to finishing processes to provide a modified or completed fused rail assembly 320′ (FIG. 4G), all of the first and second rails 322, 328 and the first and second extension portions 303, 305 preferably are horizontally (or substantially horizontally) aligned, to permit wheels of railway vehicles to roll over the modified or completed fused rail assembly 320′.

As can be seen in FIGS. 4E and 4F, in one embodiment, excess top material 350 and excess side material 352 may be extruded outwardly past the rail heads 323, 330 of the first and second rails 322, 328. The material is from the heated portions, squeezed outwardly when the first and second rails 322, 328 are pushed against the intermediate element 366. Such material preferably is removed by utilizing suitable finishing processes. Those skilled in the art would be aware of such finishing processes.

The excess top material 350 preferably is removed so that the head top surfaces 354A, 354B of the heads 323, 330 are unobstructed by the material 350, and are aligned (FIG. 4E). The excess side material 352 is removed so that the field head sides 356A, 356B of the heads 323, 330 are unobstructed by the material 342, and aligned (FIG. 4F). Also, and as can be seen in FIG. 4F, the excess side material 352 preferably is removed so that the gauge head sides 358A, 358B of the heads 323, 330 are unobstructed by the material 352, and aligned.

As can be seen in FIG. 4C, the body 301 of the intermediate element 366 may include a plate portion 386 that extends outwardly relative to the rails 322, 328 once the fused rail assembly 320 is formed. Preferably, the plate portion 386 of the intermediate element 366 in the fused rail assembly 320 is subjected to one or more additional finishing processes to provide a modified intermediate element 366′ that includes an intermediate element top surface 388 that is aligned with head top surfaces 354A, 354B of the first and second rails 322, 328 (FIG. 4G). It is also preferred that the plate portion 386 is further subjected to the additional finishing processes, to provide field and gauge intermediate element head sides of the modified intermediate element 366′ that are aligned, respectively, with the field head sides 356A, 356B of the heads 323, 330 and with the gauge head sides 358A, 358B of the heads 323, 330. The gauge intermediate head side 389B is shown in FIG. 4G. Those skilled in the art would be aware of suitable finishing processes for removal of at least parts of the plate portion 386.

As can be seen in FIG. 4G, once the plate portion 386 is removed to provide the modified intermediate element 366′, the balance of the body 301 remaining has a profile that is aligned with the design profiles “D_{E}” of the extension portions 303, 305 and with the profiles of the first and second rails 322, 328, to permit rail wheels (not shown) to roll over the first and second rails 322, 328 and the modified intermediate element 366′. The completed or modified fused rail assembly shown in FIG. 4G is identified by reference character 320′.

Each of the extension portions 303, 305 extends axially from the body 301 of the intermediate element 366. It is believed that, because of the depth of the extension portions 303, 305, they provide a relative even distribution of heat therein when the heating elements 340A, 340B are energized. The extension portions 303, 305 preferably serve to control heat distribution, confining heat therein.

As noted above, the heating elements 340A, 340B may be configured to transfer additional heat energy to the heads 323, 330 of the rails 322, 328, upon energization of the heating elements 340A, 340B. For more even heat distribution, preheating may be utilized with respect to the parts of the extension portions 303, 305 that correspond to the heads 323, 330.

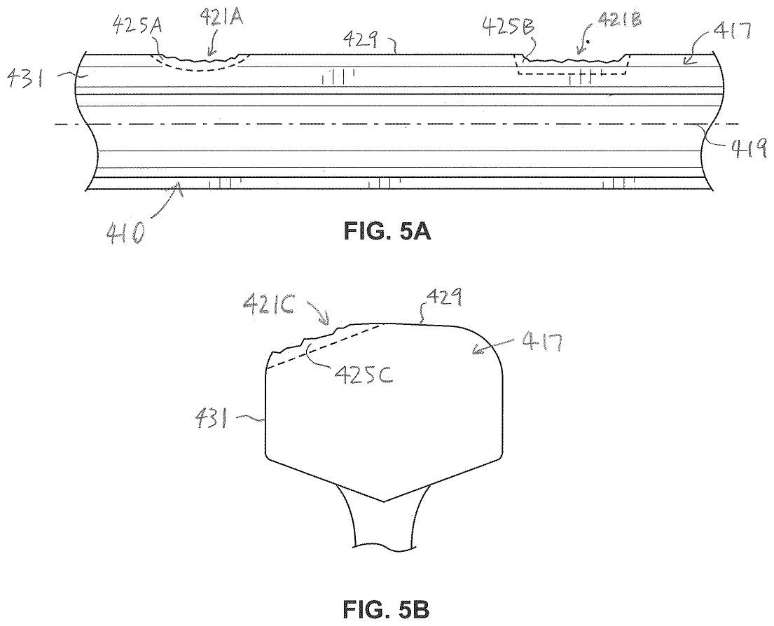

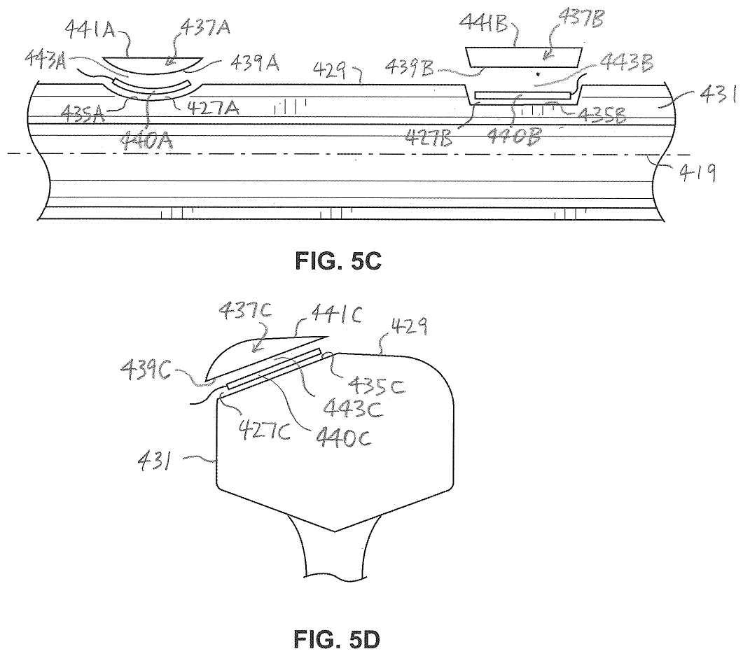

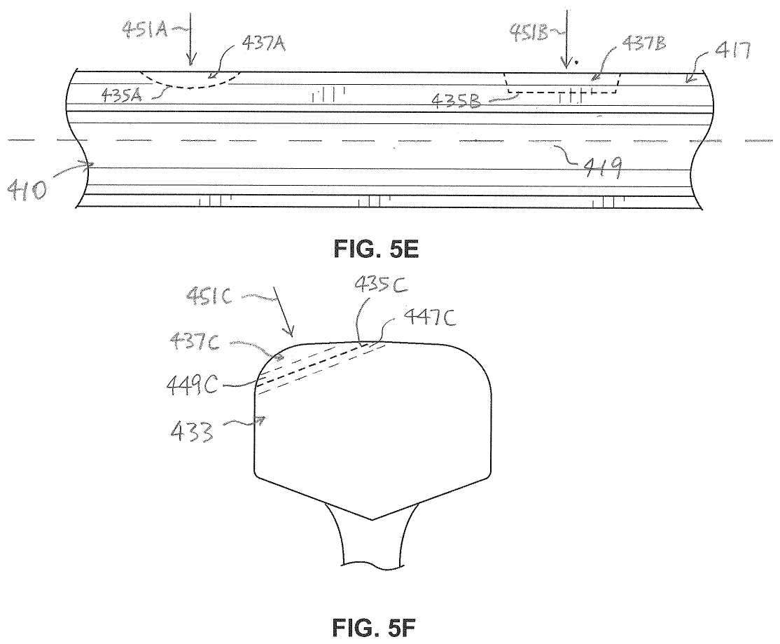

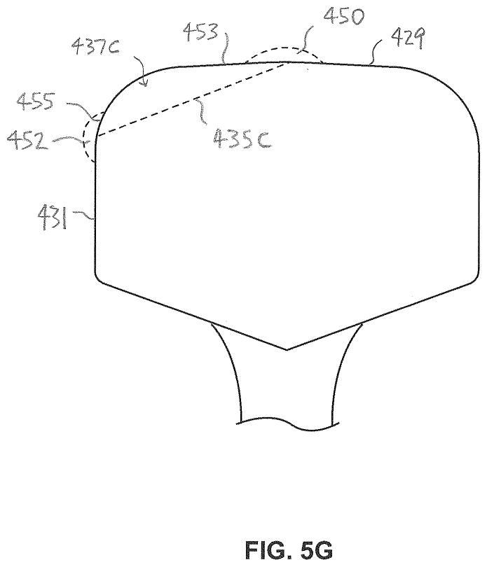

As can be seen in FIGS. 5A and 5B, a head 417 of a rail 410 may be damaged due to what is referred to as “spalling”, or otherwise damaged. The damage to the head 417 may be due, at least in part, to the heat-affected zones resulting from conventional welding methods. In FIG. 5A, the head 417 as illustrated has two regions that are damaged, identified for convenience by reference characters 421A and 421B. Another view of the head 417 is provided in FIG. 5B, in which the damaged region is identified by reference character 421C. The rail 410 preferably defines a center line 419 thereof.

As can be seen in FIGS. 5A and 5B, it is preferred that damaged portions 425A, 425B, 425C are removed from the head 417, to provide cavities 427A, 427B, 427C in the head 417, relative to adjacent reference surfaces. As can be seen in FIGS. 5A-5D, the reference surfaces are a crown or top surface 429 of the head 417 and a side face 431 thereof.

As can be seen in FIGS. 5A-5G, the invention herein preferably includes a method of repairing the damaged head portion 417 of the rail 410, to provide a repaired head portion 433. Those skilled in the art would appreciate that, once the cavities 427A, 427B, 427C are formed, surfaces of walls 435A, 435B, 435C defining the cavities 427A, 427B, 427C respectively preferably are cleaned and otherwise prepared for the repair process, described below.

It will be understood that replacement elements 437A, 437B, 437C are formed to at least partially fill the respective cavities 427A, 427B, 427C, and each of the replacement elements is formed to fit into a specific cavity. Preferably, each of the replacement elements 437A, 437B, 437C includes one or more engagement surfaces 439A, 439B, 439C that is shaped for engagement with the cavity wall of the cavity that the replacement element is intended to fill. Each of the replacement elements 437A, 437B, 437C preferably also includes one or more exterior surfaces 441A, 441B, 441C respectively. As will be described, each of the exterior surfaces 441A, 441B, 441C preferably is formed to be located in a predetermined position relative to the reference surfaces 429, 431, when the replacement element 437A, 437B, 437C fills the respective cavities 427A, 427B, 427C.

Preferably, each of the replacement elements 437A, 437B, 437C is positioned to locate the engagement surfaces 439A, 439B, 439C thereof spaced apart from the surfaces of the respective cavity walls to define respective gaps 443A, 443B, 443C therebetween (FIGS. 5C, 5D). One or more heating elements preferably are positioned in each of the gaps. For clarity of illustration, the heating elements are identified in FIGS. 5C and 5D by reference characters 440A, 440B, 440C. It will be understood that non-oxidizing atmospheres are provided that cover the respective engagement surfaces 439A, 439B, 439C and also cover the cavity walls 435A, 435B, 435C while the heating elements are energized. For clarity of illustration, the regions covered by the non-oxidizing atmospheres and the covers therefor are omitted from FIGS. 5A-5F.

Once the non-oxidizing atmospheres are in place, the heating elements are energized. In each of the examples illustrated in FIGS. 5C and 5D, the heating element heats a surface of the cavity wall, a rail head portion extending from the surface into the head 417, the engagement surface of the replacement element for the cavity, and a replacement element portion extending from the engagement surface into the replacement element to a predetermined hot working temperature. The surface of the cavity wall, the rail head portion, the engagement surface, and the replacement element portion are sometimes collectively or individually herein referred to as the heated portions. When the heated portions are at the predetermined hot working temperature, they are plastically deformable.

Referring to FIGS. 5D and 5F as an example, the energized heating element 440C heats the surface of the cavity wall 435A, a rail head portion 447C extending from the surface into the head 417, the engagement surface 439C, and a replacement element portion 449C extending from the engagement surface 439C into the replacement element 437C. It will be understood that the cavity walls 435A, 435B and the replacement elements 437A, 437B are heated to the same extent by the respective heating elements 440A, 440B. In FIGS. 5C and 5E, the rail head portions and the replacement element portions that are heated by the respective heating elements are omitted, for clarity of illustration.

Preferably, the replacement element 437A, 437B, 437C is moved at least partially transversely relative to the rail center line 419 and then, while the replacement element is moving transversely, and while the heated portions are at the predetermined hot working temperature, the engagement surface thereof is engaged with the cavity wall. For example, in FIGS. 5E and 5F, the direction in which each of the replacement elements 437A, 437B, and 437C is moved for engagement of the engagement surfaces thereof with the respective cavity walls is generally indicated by arrows 451A, 451B, 451C respectively.

Due to the transverse motion of the replacement element when the engagement surface engages the cavity wall in each case, the engagement surface of each respective replacement element and the cavity wall which the engagement surface is formed to engage are fused together, to form the repaired head portion 433 (FIGS. 5E, 5F).

The repaired head portion 433 preferably is cooled, or allowed to cool, to an ambient temperature.

When the engagement surface is engaged with the cavity wall, a part of the heated portions may be squeezed outwardly, to be positioned on the crown surface 429 or the side face 431. This situation is illustrated in FIG. 5G, in which excess top material 450 and excess side material 452 are shown. In the example illustrated in FIG. 5G, the excess top material 450 is at least partially positioned on the crown portion 429, and the excess side material 452 is at least partially positioned on the side portion 431. Preferably, the repaired head portion 433 is subjected to one or more head portion finishing processes to align the exterior surface with the relevant reference surface.

As can be seen in FIG. 5G, the exterior surface 441C includes a top exterior surface 453 that is formed to be aligned with the crown surface 429, when the replacement element 437C is positioned in the cavity 427C. The exterior surface 441C also includes a side surface 455 that is formed to be aligned with the side surface 431, when the replacement element 437C is positioned in the cavity 427C.

Those skilled in the art would appreciate that the excess top material 450 and the excess side material 452 may be removed by any suitable finishing process or processes. In the event that the exterior surface 441C is otherwise not satisfactorily aligned with the relevant reference surface therefor, suitable finishing processes may be applied to correct any misalignment.

It will be understood that the sequence in which certain steps of the embodiments of the method of the invention are performed may be varied without materially affecting the results produced by such embodiments.

It will also be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A method of forming a fused rail assembly comprising:
(a) providing a first rail comprising a first rail head, the first rail defining a first rail center line thereof, the first rail ending at a first end face thereof;
(b) providing a second rail comprising a second rail head, the second rail defining a second rail center line thereof, the second rail ending at a second end face thereof;
(c) positioning the first and second rails to locate the first and second end faces facing each other and to align the first and second rail center lines, the first and second end faces being spaced apart from each other by a predetermined distance to define a gap between the first and second end faces;
(d) providing at least one heating element located in the gap;
(e) providing a non-oxidizing atmosphere covering the first and second end faces;
(f) energizing said at least one heating element, to heat the first end face and a first length portion of the first rail extending from the first end face into the first rail by induction heating to a predetermined hot working temperature, at which the first end face and the first length portion are plastically deformable, and to heat the second end face and a second length portion of the second rail extending from the second end face into the second rail by induction heating to the predetermined hot working temperature, at which the second end face and the second length portion are plastically deformable;
(g) subjecting at least one of the first and second rails to transverse motion in at least one direction that is at least partially transverse to the first and second rail center lines; and
(h) while said at least one of the first and second rails is subjected to said transverse motion, and while the first end face and the first length portion and the second end face and the second length portion are at the predetermined hot working temperature, engaging the first and second end faces with each other, to at least partially plastically deform the first and second end faces and the first and second length portions,
wherein the first and second end faces and the first and second length portions are at least partially fused together to form the fused rail assembly.

2. A method according to claim 1 additionally comprising:
(i) cooling the fused rail assembly to an ambient temperature.

3. A method according to claim 1 in which excess top material on respective head top surfaces of the first and second rail heads of the fused rail assembly is subjected to at least one finishing process, to align the respective head top surfaces with each other, and excess side material on respective field and gauge head sides of the first and second rail heads of the fused rail assembly is subjected to said at least one finishing process, to align the field head sides of the first and second rail heads with each other, and to align the gauge head sides of the first and second rail heads with each other.

4. A method according to claim 1 in which, in step (f), the first length portion comprises a first central region that is aligned with a first central head area and a first outer region that is adjacent to the first central region, and the second length portion comprises a second central region that is aligned with a second central head area and a second outer region that is adjacent to the second central region, and the first central region and the second central region are both heated by said at least one heating element to a greater extent over time than the first and second outer regions.

5. A method of forming a fused rail assembly, comprising:
(a) providing a first rail comprising a first rail head, the first rail defining a first rail center line thereof, the first rail ending at a first end face thereof;
(b) providing a second rail comprising a second rail head, the second rail defining a second rail center line thereof, the second rail ending at a second end face thereof;
(c) positioning the first and second rails to locate the first and second end faces facing each other and to align the first and second rail center lines, the first and second end faces being spaced apart from each other by a predetermined distance to define an opening between the first and second end faces;
(d) providing an intermediate element comprising first and second sides thereof;
(e) positioning the intermediate element in the opening between the first and second end faces, to define a first gap between the first end face and the first side, and to define a second gap between the second end face and the second side, the first and second sides respectively comprising first and second contact surfaces for engagement with the first and second end faces respectively;
(f) providing at least one first heating element in the first gap;
(g) providing at least one second heating element in the second gap;
(h) providing a non-oxidizing atmosphere covering the first and second end faces and the first and second contact surfaces;
(i) energizing said at least one first heating element, to heat the first end face and a first length portion of the first rail extending from the first end face into the first rail to a predetermined hot working temperature, at which the first end face and the first length portion are plastically deformable, and to heat the first contact surface and a first intermediate element portion of the intermediate element extending from the first contact surface into the intermediate element to the predetermined hot working temperature, at which the first contact surface and the first intermediate element portion are plastically deformable;
(j) energizing said at least one second heating element, to heat the second end face and a second length portion of the second rail extending from the second end face into the second rail to the predetermined hot working temperature, at which the second end face and the second length portion are plastically deformable, and to heat the second contact surface and a second intermediate element portion of the intermediate element extending from the second contact surface into the intermediate element to the predetermined hot working temperature, at which the second contact surface and the second intermediate element portion are plastically deformable;
(k) subjecting at least one of the first and second rails to transverse motion in at least one direction that is at least partially transverse to the first and second rail center lines; and
(l) while said at least one of the first and second rails is subjected to said transverse motion, and while the first end face, the first length portion, the first contact surface, the first intermediate element portion, the second end face, the second length portion, the second contact surface, and the second intermediate element portion are at the predetermined hot working temperature, engaging the first and second end faces with the first and second contact surfaces respectively, to at least partially plastically deform the first end face, the first length portion, the first contact surface, and the first intermediate element portion, and to at least partially plastically deform the second end face, the second length portion, the second contact face, and the second intermediate element portion,
wherein the first end face, the first length portion, the first contact surface, the first intermediate element portion, are fused together, and the second end face, the second length portion, the second contact surface, and the second intermediate element portion are fused together, to form the fused rail assembly.

6. A method according to claim 5 additionally comprising, in step (k), additionally subjecting the intermediate element to transverse motion in at least one intermediate element direction that is at least partially transverse to an intermediate center line thereof, and moves the intermediate element relative to the first and second end faces.

7. A method according to claim 5 additionally comprising:
(m) cooling the fused rail assembly to an ambient temperature.

8. A method according to claim 5 in which excess top material on respective head top surfaces of the first and second rail heads of the fused rail assembly is subjected to at least one finishing process, to remove the excess top material for aligning the respective head top surfaces with each other, and excess side material on respective field and gauge head sides of the first and second rail heads of the fused rail assembly is subjected to said at least one finishing process, to remove the excess side material for aligning the field head sides of the first and second rail heads with each other, and to align the gauge head sides of the first and second rail heads with each other.

9. A method according to claim 5 in which a plate portion of the intermediate element is subjected to at least one finishing process to provide an intermediate element head top surface aligned with the head top surfaces of the first and second rails, and to provide respective field and gauge intermediate element head sides, the field intermediate element head side being aligned with the field head sides of the first and second rail heads, and the gauge intermediate element head side being aligned with the gauge head sides of the first and second rail heads.

10. A method according to claim 5 in which, in steps (h) and (i), the first length portion comprises a first central region that is aligned with a first central head area of the first rail head and a first outer region that is adjacent to the first central region, and the second length portion comprises a second central region that is aligned with a second central head area of the second rail head and a second outer region that is adjacent to the second central region, and the first central region and the second central region are heated by said at least one first heating element and heated by said at least one second heating element respectively to a greater extent over time than the first and second outer regions.

11. A method of forming a fused rail assembly, comprising:
(a) providing a first rail comprising a first rail head, the first rail defining a first rail center line thereof, the first rail ending at a first end face thereof;
(b) providing a second rail comprising a second rail head, the second rail defining a second rail center line thereof, the second rail ending at a second end face thereof;
(c) positioning the first and second rails to locate the first and second end faces facing each other and spaced apart from each other by a predetermined distance to define an opening between the first and second end faces;
(d) providing an intermediate element comprising first and second sides thereof;
(e) positioning the intermediate element in the opening between the first and second end faces, to define a first gap between the first end face and a first side of the intermediate element, and to define a second gap between the second end face and a second side of the intermediate element, the first and second sides respectively comprising first and second contact surfaces for engagement with the first and second end faces respectively;
(f) providing at least one first heating element in the first gap;
(g) providing at least one second heating element in the second gap;
(h) providing a non-oxidizing atmosphere covering the first and second end faces and the first and second contact surfaces;
(i) energizing said at least one first heating element, to heat the first end face and a first length portion of the first rail extending from the first end face into the first rail to a predetermined hot working temperature, at which the first end face and the first length portion are plastically deformable, and to heat the first contact surface and a first intermediate element portion of the intermediate element extending from the first contact surface into the intermediate element to the predetermined hot working temperature, at which the first contact surface and the first intermediate element portion are plastically deformable;
(j) energizing said at least one second heating element, to heat the second end face and a second length portion of the second rail extending from the second end face into the second rail to the predetermined hot working temperature, at which the second end face and the second length portion are plastically deformable, and to heat the second contact surface and a second intermediate element portion of the intermediate element extending from the second contact surface into the intermediate element to the predetermined hot working temperature, at which the second contact surface and the second intermediate element portion are plastically deformable;
(k) subjecting the intermediate element to transverse motion in at least one direction that is at least partially transverse to the first and second rail center lines; and
(l) while said intermediate element is subjected to said transverse motion, and while the first end face, the first length portion, the first contact surface, the first intermediate element portion, the second end face, the second length portion, the second contact surface, and the second intermediate element portion are at the predetermined hot working temperature, engaging the first and second end faces with the first and second contact surfaces respectively, to at least partially plastically deform the first end face, the first length portion, the first contact surface, and the first intermediate element portion, and to at least partially plastically deform the second end face, the second length portion, the second contact surface, and the second intermediate element portion,
wherein the first end face, the first length portion, the first contact surface, the first intermediate element portion, the second end face, the second length portion, the second contact surface, and the second intermediate element portion are fused together to form the fused rail assembly.

12. A method according to claim 11 in which, in step (k), at least one of the first and second rails is additionally subjected to transverse motion in at least one direction that is at least partially transverse to the first and second rail center lines.

13. A method according to claim 11 additionally comprising:
(m) cooling the fused rail assembly to an ambient temperature.

14. A method according to claim 11 in which:
excess rail material on respective head top surfaces of the first and second rail heads is subjected to at least one rail finishing process, to remove the excess rail material for aligning the respective head top surfaces with each other, and respective field and gauge head sides of the first and second rail heads are further subjected to said at least one rail finishing process, to remove the excess rail material for aligning the field head sides of the first and second rail heads with each other, and to remove the excess rail material for aligning the gauge head sides of the first and second rail heads with each other; and
excess intermediate element material on the intermediate element is subjected to said at least one finishing process, to provide an intermediate element head top surface aligned with the respective head top surfaces of the first and second rails, and to provide respective field and gauge intermediate element head sides, the field intermediate element head side being aligned with the field head sides of the first and second rail heads, and the gauge intermediate element head side being aligned with the gauge head sides of the first and second rail heads.

15. A method of forming a fused rail assembly, comprising:
(a) providing a first rail comprising a first rail head, the first rail defining a first rail center line thereof, the first rail extending at a first end face thereof;
(b) providing a second rail comprising a second rail head, the second rail defining a second rail center line thereof, the second rail ending at a second end face thereof;
(c) positioning the first and second rails to locate the first and second end faces facing each other and spaced apart from each other by a predetermined distance to define an opening between the first and second end faces;
(d) providing an intermediate element comprising a body having first and second sides thereof, the intermediate element additionally comprising first and second extension portions thereof extending in opposite directions from the first and second sides respectively to define respective first and second extension faces thereof;
(e) positioning the intermediate element in the opening between the first and second end faces, to define a first gap between the first end face and the first extension face of the intermediate element, and to define a second gap between the second end face and the second extension face of the intermediate element;
(f) providing at least one first heating element in the first gap;
(g) providing at least one second heating element in the second gap;
(h) providing a non-oxidizing atmosphere covering the first and second end faces and the first and second extension faces;
(i) energizing said at least one first heating element, to heat the first end face and a first length portion of the first rail extending from the first end face into the first rail to a predetermined hot working temperature, at which the first end face and the first length portion are plastically deformable, and to heat the first extension face and a first intermediate element portion of the intermediate element extending from the first extension face into the intermediate element to the predetermined hot working temperature, at which the first extension face and the first intermediate element portion are plastically deformable;
(j) energizing said at least one second heating element, to heat the second end face and a second length portion of the second rail extending from the second end face into the second rail to the predetermined hot working temperature, at which the second end face and the second length portion are plastically deformable, and to heat the second extension face and a second intermediate element portion of the intermediate element extending from the second extension face into the intermediate element to the predetermined hot working temperature, at which the second extension face and the second intermediate element portion are plastically deformable;
(k) subjecting the intermediate element to transverse motion in at least one direction that is at least partially transverse to an intermediate element center line; and
(l) while said intermediate element is subjected to said transverse motion, and while the first end face, the first length portion, the first extension face, the first intermediate element portion, the second end face, the second length portion, the second extension face, and the second intermediate element portion are at the predetermined hot working temperature, engaging the first and second end faces with the first and second extension faces respectively, to at least partially plastically deform the first end face, the first length portion, the first extension face, the first intermediate element portion, and to at least partially plastically deform the second end face, the second length portion, the second extension face, and the second intermediate element portion,
wherein the first end face, the first length portion, the first extension face, the first intermediate element portion, the second end face, the second length portion, the second extension face, and the second intermediate element portion are fused together to form the fused rail assembly.

16. A method according to claim 15 in which, in step (k), at least one of the first and second rails is additionally subjected to transverse motion in at least one direction that is at least partially transverse to the first and second rail center lines.

17. A method of repairing a damaged head portion of a rail to provide a repaired head portion, the rail defining a rail center line thereof, the damaged head portion comprising at least one cavity thereon relative to at least one reference surface adjacent to said at least one cavity, said at least one cavity being defined by at least one cavity wall, the method comprising:
(a) cleaning at least one surface of said at least one cavity wall;
(b) providing at least one replacement element formed to at least partially fill said at least one cavity, said at least one replacement element comprising:
at least one engagement surface thereof, shaped for engagement with said at least one surface of said at least one cavity wall, and
at least one exterior surface, formed to be located in a predetermined position relative to said at least one reference surface, when said at least one replacement element fills said at least one cavity;
(c) positioning said at least one replacement element to locate said at least one engagement surface spaced apart from said at least one surface of said at least one cavity wall to define a gap therebetween;
(d) positioning at least one heating element in the gap;
(e) providing a non-oxidizing atmosphere covering said at least one surface of said at least one cavity wall and said at least one engagement surface;
(f) energizing said at least one heating element, to heat said at least one surface of said at least one cavity wall, a rail head portion extending from said at least one surface of said at least one cavity wall into the damaged head portion, and to heat said at least one engagement surface and a replacement element portion extending from said at least one engagement surface into the replacement element, to a predetermined hot working temperature at which said at least one surface of said at least one cavity wall, the rail head portion, said at least one engagement surface, and the replacement element portion are at least partially plastically deformable;
(g) moving said at least one replacement element at least partially transversely relative to the rail center line;
(h) while said at least one replacement element is moving at least partially transversely relative to the rail center line, and while said at least one surface of said at least one cavity wall, the rail head portion, said at least one engagement surface, and the replacement element portion are at the hot working temperature, engaging said at least one engagement surface with said at least one surface of said at least one cavity wall, to at least partially plastically deform said at least one surface of said at least one cavity wall, the rail head portion, said at least one engagement surface, and the replacement element portion,
wherein said at least one surface of said at least one cavity wall, the rail head portion, said at least one engagement surface, and the replacement element portion are at least partially fused together, to form the repaired head portion.

18. A method according to claim 17 additionally comprising:
(i) cooling the repaired head portion to an ambient temperature.

19. A method according to claim 17 in which excess material on the repaired head portion is subjected to at least one head portion finishing process to remove the excess material for aligning said at least one exterior surface with said at least one reference surface.
